(19) United States
(12) Patent Application Publication
(10) Pub. No.: US 2005/0005127 A1
(43) Pub. Date: Jan. 6, 2005

(54) Method of verifying entitlement to participate in a gaming event from a remote location

(76) Inventors: Richard E. Rowe, Incline Village, NV (US); Michael M. Oberberger, Reno, NY (US)

Correspondence Address: BEYER WEAVER & THOMAS LLP, P.O. BOX 778, BERKELEY, CA, 94704-0778, US

(21) Appl. No.: 10/494,664

(22) PCT Filed: Nov. 13, 2002
(86) PCT No.: PCT/US02/36690

Related U.S. Application Data
(60) Provisional application No. 60/338,361, filed on Nov. 14, 2001.

(51) Int. Cl. H04K 1/00

(52) U.S. Cl. 713/182

(57) ABSTRACT

In a first step (S1), a prospective gaming patron preferably enrolls to establish entitlement to participate in a gaming event. This step includes the patron providing a variety of information, including identification information. Preferably, this information is of a nature which permits the gaming event provider to verify the patron's identity. For example, the patron may provide a state drivers license, a federal Social Security number or card, birth certificate, passport or the like for the purpose of ensuring that the individual who is enrolling is the person they purport to be. In a step (S2), a file is created regarding the patron. Generally, this file will only be created in the event the patron is determined to meet the requirements for participating in a gaming event. In a step (S3), the player establishes communication with the game server. In a step (S4), the user transmits authentication information to the game server. The authentication information is compared to authentication information contained in the file or files corresponding to the patron. In a step (S5), the game server preferably generates identification information and transmits it to the patron, such as by sending the information to the patron's computer for storage in memory. In a step (S6), the game server established, preferably via a separate communication link or pathway, that the identification information is present at the patron's computer. In a step (S7), the patron is provided access to the game server for participating in one of more gaming events.

### FIELD OF THE INVENTION

The present invention relates to methods for verifying the identity and/or location of a person, and more particularly such methods utilized for purposes of determining entitlement of a person to participate in an event.

### BACKGROUND OF THE INVENTION

One activity which has and continues to garner substantial interest is the ability to permit a party to engage in a gambling or gaming event from a remote location. This interest is evidence by a number of patents have been issued which relate to methods for presenting games and facilitating payment for wagers and payouts for remotely located players. In addition, many companies have announced that they are involved in researching and developing the technology to present gaming events to remote customers. Several websites currently exist which actually permit players to engage in on-line gambling.

Currently, these websites and their operators, however, are not operating with the approval the U.S. federal government or any state government. In fact, such operations may violate one of several laws, including the U.S. Wire Act of 1961 (18 U.S.C. §1084) and the U.S. Travel Act of 1961 (18 U.S.C. § 1952). As a result, most of these website operators are located outside of the United States.

Because of the great public interest in on-line gambling, several versions of federal legislation have recently been proposed directed specifically at regulating on-line gambling. This legislation is generally framed in various forms to address the numerous different concerns raised by the various States and the federal government related to on-line gambling.

One concern that is generally raised in support of this legislation is the inability to determine the identity of a remote gambler, or the location of the remote gambler. For example, it is generally accepted that, regardless of location, a minor (under the age of 21) should not be permitted to participate in gambling events. Further, several states do not permit gambling in any form, and many other states permit only certain types of gaming events. Thus, it is deemed important to ensure that a customer not be permitted to engage in an on-line gaming event if they are located in a state which does not permit participation in such an event.

A reliable and convenient method for verifying the identity and/or location of a perspective gaming patron is desired.

### SUMMARY OF THE INVENTION

The invention is a method for verifying the identity and/or location of a prospective patron who is located remotely from a game event provider and who desires to participate in a gaming or gambling event.

In one embodiment, the method is implemented via a system which includes at least one game server, a patron computer or player device, and one or more communication links. The communication links may comprise telephone lines or connections provided by local and long distance carriers, the Internet, cellular networks and the like. The patron computer may be a desktop, laptop or other computing device which includes at least one communication interface for connection to one of the communication links.

The game server may comprise a computing device or a number of devices cooperating with one another. In general, the game server is arranged to generate and store certain information, as well as transmit and receive information. The game server is configured to present game or gambling event information to a verified patron. The game server also includes a communication interface for connection to one of the communication links.

In one embodiment of a method, a patron enrolls with a game event provider. The enrollment process includes the patron providing identification information allowing the game event provider to verify the identity of the patron. In one embodiment, the patron enrolls in person.

The game event provider may utilize the patron provided information to determine if the patron is eligible for enrollment. For example, the game event provider may verify the age of the patron, the residence of the patron and the credit worthiness of the patron.

If the patron is accepted, a file is generated and stored at or in association with the game server. The file contains data regarding the patron. In one embodiment, a password, user identification or other authentication information is associated with the patron's file.

When a patron wishes to participate in a gaming event from a remote location, the patron forms a communication link with the game server. In one embodiment, this step comprises the patron using their computer to establish a communication link with the game server via a telephone line connection, the Internet or the like.

Once the communication link is established, the patron transmits their authentication information. The game server verifies this information against the authentication information stored in the patron's file. If this information is incorrect, the patron is prevented from participating in a gaming event.

If the authentication information is correct, in one embodiment the game server generates identification information and transmits it to the patron's computer for storage. In one embodiment, the information is transmitted in the form of a cookie.

Next, the game server verifies the identification information stored at the patron's computer. In one embodiment, this step includes the game server establishing an independent communication link with the patron's computer. This independent link may be formed via a call back or return Internet Protocol procedure. The game server looks for the information, such as the cookie, to verify its form and content.

If the identification information is verified by the game server, then the patron's identity and/or location are verified and the patron is permitted to participate in game or gambling events. Such events may comprise wagering on sports or other events, or playing on-line video-style games.

Other embodiments of methods of the invention are disclosed.

Further objects, features, and advantages of the present invention over the prior art will become apparent from the detailed description of the drawings which follows, when considered with the attached figures.

### DESCRIPTION OF THE DRAWINGS

FIG. 1 illustrates an environment in which the method of the invention may be practiced;

FIG. 2 is a flow diagram illustrating one embodiment of a method of the invention;

FIG. 3 schematically illustrates one method of the invention;

FIG. 4 schematically illustrates another method of the invention; and

FIG. 5 schematically illustrates yet another method of the invention.

### DETAILED DESCRIPTION OF THE INVENTION

The invention is a method for determining the identity and/or location of a remote gaming patron. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

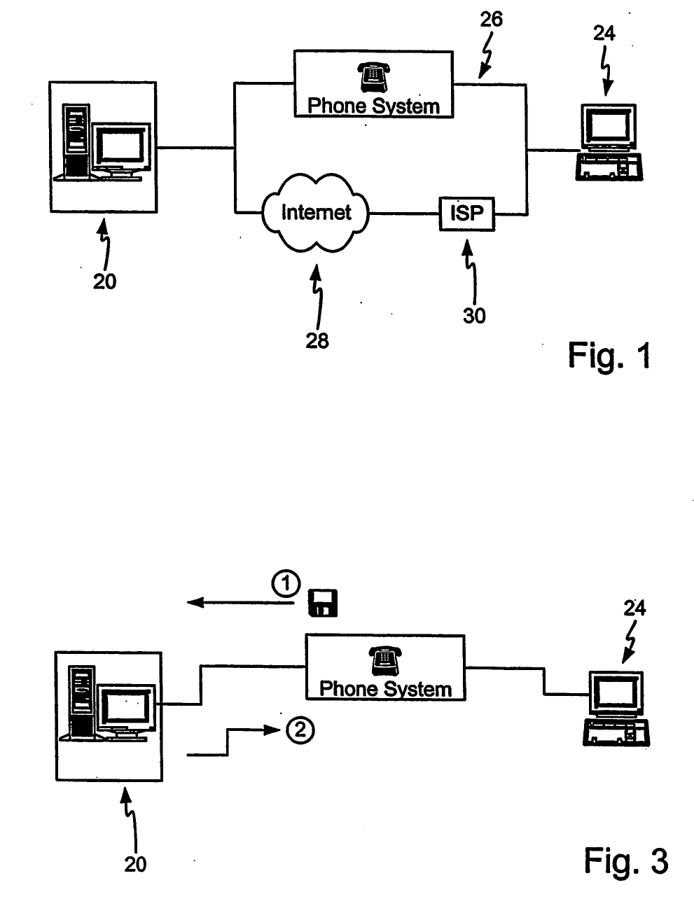

FIG. 1 illustrates one environment in which the method of the invention may be practiced. The environment includes a game server 20. The game server 20 may comprise a variety of combinations of hardware and/or software. In general, the game server 20 is adapted to facilitate the presentation of or directly present a gaming or gambling event to patron who is located remotely.

The game server 20 may comprise a computing device including a processor and a memory. Preferably, the game server 20 includes, or is associated with, a communication interface permitting information to be transmitted to and received from another device. The communication interface may be arranged to implement a wired or wireless communication protocol, such as, for example, a cabled RS-232 or IEEE-1394 (Firewire™) connection/protocol, or a wireless infrared transmitter/receiver or IEEE-802.11(b) (Bluetooth™)connection/protocol.

In one embodiment, the game server 20 may comprise multiple devices. For example, the game server 20 may comprise a data storage device, a communication interface, a processing device and/or other devices connected to one another, such as located on a local area network (LAN).

With respect to the presentation of a gaming event, the game server 20 may be configured in a variety of ways. For example, the game server 20 may be arranged to accept player identification information, accept wager or bet information, accept player game input, generate game event information, determine gaming event outcome, generate winning or award information, and generate or present a wide variety of other events/information.

The types of gaming events which may be presented utilizing the game server 20 may be varied. For example, the game server 20 may be arranged to accept sports or other event bets. The game server 20 may also be arranged to generate video game information, such as video slot or video poker game information. In general, the game server 20 may be arranged to generate game information in a manner similar to a wide variety of known games which are already presented on stand-alone or networked gaming machines.

As illustrated in FIG. 1, the game server 20 is preferably in communication at one or more times with one or more remote patron or customer devices/computers 24 via one or more communication links or pathways. In one embodiment, there may be more than one communication link or pathway, and such may be varied. One such communication pathway may be via phone lines 26, such as through local and long-distance telecommunication carriers. Such a pathway may be referred to as a direct connection, in that the end points of the communication pathway remain dedicated to one another during a particular communication session. It will be understood that this pathway may vary depending on a variety of factors, including the mode of data transfer. For example, the pathway may be through land lines, or through wireless links, such as satellite links. The pathway may also include one or more cellular wireless links.

Another communication pathway may be by a global communication network such as the Internet 28. As is known, the Internet is a collection of devices arranged as nodes. Addresses are assigned to the devices, permitting packets of data to be routed through the network from one device to another intended device. In the configuration of the Internet, information is packetized and individual packets of data sent from one device to another may be routed over a variety of pathways through the various nodes of the network.

Within the framework of the Internet, devices which form the Internet itself are deemed “on” the Internet. Each of these devices is assigned a unique internet protocol (IP) address. These addresses may be referred to as static, as the address for a particular device stays the same over time and is consistently utilized to identify that particular device.

Other devices which are not located “on” the Internet may be connected to the Internet to transmit and receive information. In one embodiment, a device not located on the Internet establishes a communication link with a device which is on the Internet. The device which is on the Internet may be an Internet Service Provider (ISP) 30. In order to permit communications between a device which is not on the Internet but connected thereto such as by an ISP, and other devices, the device must be assigned an IP address. Generally, these devices are assigned “dynamic” addresses, or addresses which change over time. For example, an ISP may be provided with a large number of addresses which may be assigned to parties which establish connections with the Internet through their service. When a party establishes a connection, their device is assigned one of the addresses from the group of addresses. This assignment permits an identification of the connected device. The address is “dynamic” in that when the device forms a subsequent connection, the ISP may assign the device a different one of the IP addresses from the group of addresses.

Of course, other types of communication links may be utilized to transmit information between the devices. These networks may include local area and wide area networks (LANs and WANs).

In general, these communication links are used to enable communication between the game server 20 and a remote patron. In one embodiment, the remote patron utilizes the computer 24. The computer 24 may be a variety of devices including hardware and/or software. In one embodiment, the computer 24 may be a desktop or laptop computer used for a variety of purposes. The computer 24 may also be specially adapted to enable the patron to participate in a gaming event.

In general, the computer 24 may include a processing device, a memory, a display, at least one input device, and at least one communication interface. The processor is preferably arranged to execute program code. The display may comprise a CRT, LED, plasma or other type of device. The input device may comprise a mouse, keyboard and/or other devices, as is well known.

In similar fashion to the game server 20, the computer 24 preferably includes a communication interface permitting information to be transmitted and received. In this regard, the computer 24 preferably includes a communication interface permitting communication via one of the pathways to the game server 20, such as the Internet 28 or phone lines 26. The computer 24 may include a telephone modem or cable modem for this purpose.

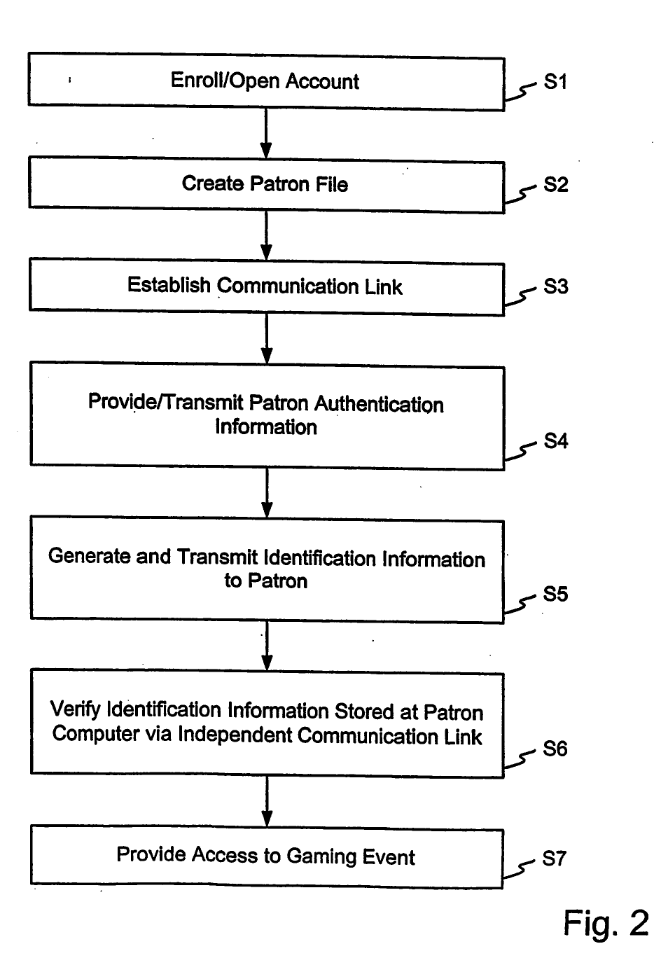

In accordance with the invention, there is provided a method for verifying the identity of a prospective gaming patron and/or identifying the location of the prospective gaming patron. One such method will be described with reference to FIG. 2.

In a first step S1, a prospective gaming patron preferably enrolls to establish entitlement to participate in a gaming event. In one embodiment, this step comprises the patron providing a variety of information, including identification information. Preferably, this information is of a nature which permits the gaming event provider to verify the patron's identity. For example, the patron may provide a state drivers license, a federal Social Security number or card, birth certificate, passport or the like for the purpose of ensuring that the individual who is enrolling is the person they purport to be. In addition, the gaming event provider preferably utilizes this information to verify that the patron is of sufficient age to participate in the event (such as determined by state law) or meets other criteria.

In one embodiment, the information provided may also include payment information such as a bank account, credit card number or the like. The information may also include location information, such as the residence address of the patron.

In one embodiment, the patron may be required to provide the information in physical presence. For example, the patron may be required to travel to a casino to establish the account. In this manner, personnel may use visual and other information to verify the provided information.

The provided information may also include biometric information. This information may include one or more of the patron's fingerprints, a retina scan or the like. In another embodiment, the information which is provided for identification purposes is a through a third party authentication/identification service, such as Microsoft Passport™. In such an event, identification of the patron may be provided through use of their password and confirmation using that service.

In one embodiment, in a step S2, a file is created regarding the patron. Generally, this file will only, be created in the event the patron is determined to meet the requirements for participating in a gaming event. For example, if the patron is determined to be minor, then no file or account may be generated.

The file is preferably associated with the game server 20 and includes some or all of the identification information provided by the patron. As detailed below, the information in the file is preferably used in part to identify the patron when they attempt to participate in a gaming event from a remote location.

In one embodiment of the invention, a patron is assigned an access code, password and/or other authentication information. The access code, password or other authentication information may be assigned by the gaming event provider, or may be partly or entirely selected by the patron. Preferably, this information is associated with the patron's file.

In a step S3, the player establishes communication with the game server 20. As described in greater detail below, this step may be accomplished in a variety of manners. With reference to the environment illustrated in FIG. 1, the step may comprise the patron utilizing their computer 24 to establish a connection with the game server 20 via the Internet 28 or phone lines 26.

In a step S4, the user transmits authentication information to the game server 20. The authentication information is compared to authentication information contained in the file or files corresponding to the patron. This step may comprise, for example, the patron inputting a user identification (such as a last name) along with a password.

If the authentication information is accurate, then the method proceeds to step S5. If not, the patron may be informed that they may not continue because their identity can not be verified.

n step S5, the game server 20 preferably generates identification information and transmits it to the patron, such as by sending the information to the patron's computer 24 for storage in memory. As disclosed below, the information may be transmitted in a variety of forms. In one embodiment, the information is provided in the form of a “cookie” which is accepted by the patron's computer 24.

In a step S6, the game server 20 establishes, preferably via a separate communication link or pathway, that the identification information is present at the patron's computer 24. If so, then in a step S7, the patron is provided access to the game server 20 for participating in one or more gaming events. If not, then access to the patron is blocked or prevented.

Several specific embodiments of the invention will now be described in greater detail. In each of these embodiments, it is assumed that the patron has already established an account.

In one embodiment, illustrated schematically in FIG. 3, a patron may establish a communication link with the game server 20 via a phone line in a step 1. For example, the patron may utilize a modem of the computer 24 to dial the game server 20.

Once the communication link is established, the patron transmits their authentication information, such as user name and password. If the game server 20 verifies the information, then the game server 20 terminates the communication. The game server 20 then, in a step 2, establishes a communication link back to the patron. In one embodiment, the patron identifies a phone number at which their computer 24 may be accessed. This phone number may be stored in the patron's file and accessed when authentication is completed.

Using the phone number, the game server 20 establishes the communication link, preferably again via the phone lines 26. The patron's computer 24 accepts the incoming call and completes the communication link The patron is then permitted to participate in a gaming event, such as by receiving gaming event information, transmitting wager or bet information, and receiving gaming event outcome information.

It will be appreciated that in this embodiment, step S5 of the method detailed above is technically omitted, in that the game server 20 does not generate and transmit identification information for storage at the patron's computer. Instead, as indicated, verification occurs by establishing an independent communication link from the game server 20 to the patron's computer 24 utilizing the phone number information provided by the patron.

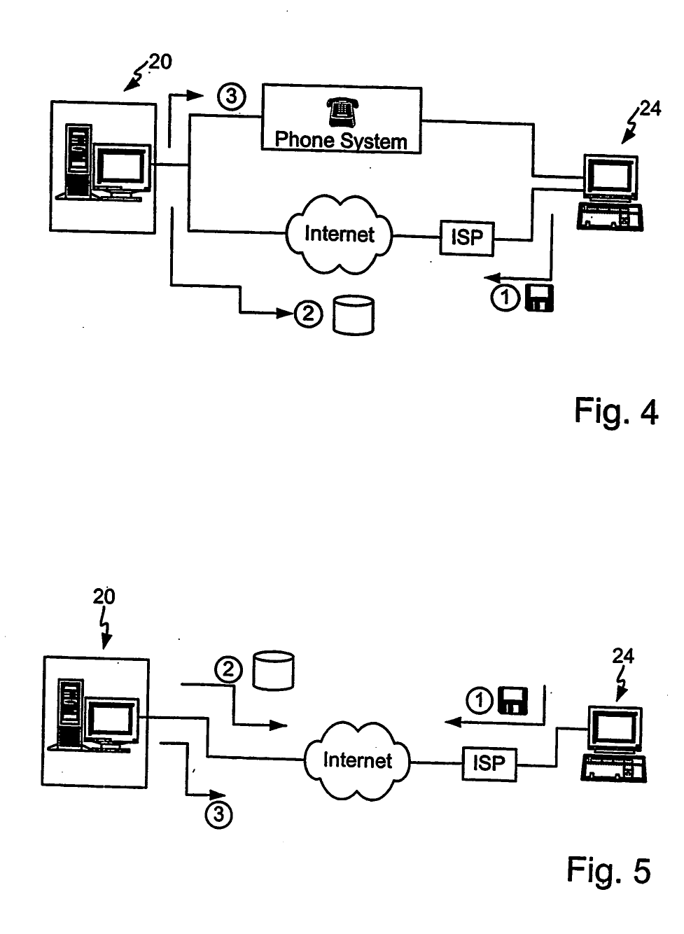

In another embodiment, illustrated schematically in FIG. 4, a patron may establish in a step 1 a communication link with the game server 20 via the Internet using a DSL or cable modem associated with their computer 24. In this embodiment, the communication link is via the Internet 28 with the cable company or DSL provider acting as the ISP. The communication link is preferably established by the patron utilizing a standard web browser and indicating the IP address of the game server 20.

Once the communication link is established, the patron transmits the authentication information. If verified, then the game server 20 transmits identification information. As described above, in one embodiment, this step 2 comprises the game server 20 transmitting a cookie to the patron's computer 24.

The game server 20 then contacts the patron's computer in a step 3. Preferably, this accomplished by a second communication link. In like manner to the method just described, in this embodiment the game server 20 establishes a separate communication link, such as via the phone lines 26. In one embodiment, the communication link is established through a phone modem associated with the patron's computer.

When the communication link is established, the game server 20 locates the cookie and utilizes the information stored in the cookie to verify the patron. The second communication link is then terminated by the game server 20. The patron is then permitted to access the game server 20 through the first communication link still established, such as for participating in a gaming event.

In yet another embodiment, illustrated schematically in FIG. 5, in a step 1 a patron establishes a communication link with the game server 20 over the Internet 28, such as via a DSL, cable or telephone dial-up connection through an ISP. Of course, if the patron's computer 24 is on the Internet, then the connection may be formed directly without connection through an ISP.

Once the communication link is formed, the patron preferably transmits authentication information. If the authentication or access information is accepted, then in a step 2 the game server 20 generates and transmits identification information. This information may be transmitted in the form of a cookie which is stored at the patron's computer.

In a step 3, the game server 20 then establishes a second communication link with the patron's computer. In this embodiment, the link is preferably through the Internet. In one embodiment, the game server 20 utilizes the IP address of the patron's computer to locate the patron's computer. The IP address may be obtained when the patron's computer first contacts the game server 20 for initiating the sequence. In another embodiment, the IP address may be obtained from the patron and stored in the patron's file.

Once a return communication link is formed from the game server 20 back to the patron's computer 24 is established, the game server 20 checks for the cookie just transmitted to the patron's computer. The information stored in the cookie is verified to verify the identity of the patron. The return communication link is then terminated and, if verification exists, the patron is permitted to engage in gaming events via the communication link which the patron established with the game server 20.

Various aspects and alternatives pertinent to the method of the invention will now be described. In accordance with one embodiment of the method, verification of patron identity is accomplished as follows. First, the patron identifies themselves using unique access or authorization information. This is useful in verifying the identity of the patron.

Second, information is transmitted to the patron, such as in the form of a cookie. This information is then verified as located at the patron's computer through use of a separate communication link. This arrangement is useful in confirming that the patron is located in an appropriate geographic location or is otherwise entitled to participate in a gaming event. In particular, in this arrangement the game event provider utilizes the call-back or information verification procedure to ensure that the identified patron is in fact the patron who has requested access.

The cookie which is written or transmitted to the patron's computer 24 may include a variety of information. For example, the cookie may include a unique code.

In general, the information which is transmitted by the server to the patron's computer may be referred to as “state” information in that it is utilized to verify a state, i.e. the identity of, the patron's computer. This state information is preferably of the type which is generated and/or transmitted by the game server 20, stored at the patron computer 24, and then used or accessed by the game server 20.

As indicated, the information may be transmitted in the form of a cookie. Cookies are often associated with Internet protocols. It will be understood, however, that the information may be transmitted in forms other than a cookie. This information need not be associated with the use of a web browser. For example, the information may be presented in the form of a Java™ applet. The information may also comprise a data file having any of a variety of forms and readable by any of a variety programs/languages.

A variety of options and additional aspects of the invention will now be described. In one embodiment, the step of enrolling a patron may involve additional aspects or steps. For example, once the patron has identified themselves, such as with appropriate verifying documents, the game event provider may check a variety of criteria to determine if the patron is entitled to enroll. These criteria may include whether the patron is a problem gambler, has bad credit or the like.

In one embodiment, each enrolling patron may be assigned a credit limit. The credit limit may be associated with a credit verification, such as verification of the status of a line of credit on a credit card account supplied by the patron. The credit limit may be associated with the patron's generated file and used to ensure that during participation in a gaming event the patron does not exceed their betting limit.

As one aspect of the invention, a method is provided for ensuring that a patron does not utilize a call forwarding feature to forward the return communication from the game server 20 to another location. In one embodiment, a patron's caller identification or identified phone number identification is stored by the game server 20. This number is compared to the patron's stored dial-back number in their account or file, as well as the actual phone number to which a communication link is formed. If all three numbers do not match, a call forwarding situation is identified and the game server 20 can be arranged to discontinue verification of the patron and prevent patron participation in a game event.

In one or more embodiments, access to the game server may be via a secure socket layer (SSL) connection, ensuring the security of the data which is transmitted to and from the patron to the game server.

It will be understood that the above described arrangements of apparatus and the method therefrom are merely illustrative of applications of the principles of this invention and many other embodiments and modifications may be made without departing from the spirit and scope of the invention as defined in the claims.

1. A method of establishing entitlement of a player to play a game at a remote location comprising the steps of:
confirming entitlement of a player to play a game from a remote location;
establishing a first communication link between a gaming server and a player device at said remote location;
accepting player identification information transmitted over said first communication link from said player device;
confirming the identity of said player;
configuring state information;
transmitting said state information from said game server to said player device via said first communication link;
terminating said first communication link;
establishing a second communication link from said game server to said player device;
confirming said state information at said player device using said second communication link; and
permitting said player to participate in a game by transmitting game information from said game server to said player at said player device.

2. The method in accordance with claim 1 wherein said state information is in the form of a cookie.

3. The method in accordance with claim 1 wherein said state information is in the form of a Java™ applet.

4. The method in accordance with claim 1 wherein said first communication link is a link over a telephone line.

5. The method in accordance with claim 1 wherein said first communication link is over at least a portion of the Internet.

6. The method in accordance with claim 1 wherein said step of confirming entitlement of said player to play a game comprises determining that said player is of legal age.

7. The method in accordance with claim 1 wherein said player device comprises a computer.

8. The method in accordance with claim 1 including creating a player account including information for establishing said second communication link with said player device.

9. The method in accordance with claim 8 wherein said information comprises a telephone number.

10. The method in accordance with claim 8 wherein said information comprises an IP address.

11. The method in accordance with claim 1 wherein said step of establishing a second communication link comprises utilizing an IP address of said player device to establish said second communication link over the Internet.

12. The method in accordance with claim 1 wherein said player identification information comprises a password.

13. A method of verifying entitlement of a player to participate in a gaming event from a player device located remotely from the event or source of the event comprising:
verifying entitlement of said player to participate in a gaming event at a future time;
storing data regarding said player at a host device;
permitting establishment of a first communication link between said player device and a host device, at least a portion of said first communication link established over the Internet;
accepting player identification information;
verifying the identity of said player by comparing at least a portion of said player identification information to said stored data regarding said player;
transmitting from said host device to said player device state information;
terminating said first communication link;
utilizing an IP address of said player device to establish a second communication link between said host device and said player device, at least a portion of said second communication link established over the Internet; and
confirming said state information stored at said player device to verify entitlement of said player to participate in a gaming event.

14. The method in accordance with claim 13 wherein said state information is in the form of a cookie.

15. The method in accordance with claim 13 wherein said state information is in the form of a Java™ applet.

16. The method in accordance with claim 13 wherein said IP address of said player is provided by said player at stored at said host device.

17. The method in accordance with claim 13 including the step of transmitting game event information to said player if said player is confirmed to be entitled to participate in said gaming event.

18. The method in accordance with claim 13 wherein said player device includes a memory and said state information is stored in said memory.

19. The method in accordance with claim 13 wherein said step of verifying entitlement comprises determining if said player is of legal age to participate in said event.
